(19) United States
(12) Patent Application Publication
(10) Pub. No.: US 2025/0038235 A1
(43) Pub. Date: Jan. 30, 2025

(54) FUEL CELL SYSTEM

(71) Applicant: DENSO CORPORATION, Kariya-city (JP)

(72) Inventors: Naoya WAKAYAMA, Kariya-city (JP); Jun KAWAMURA, Kariya-city (JP)

(21) Appl. No.: 18/915,955

(22) Filed: Oct. 15, 2024

Related U.S. Application Data
(63) Continuation of application No. PCT/JP2023/014093, filed on Apr. 5, 2023.

(30) Foreign Application Priority Data
Apr. 18, 2022 (JP) 2022-068496

(51) Int. Cl. H01M 8/04828; H01M 8/04746

(52) U.S. Cl. CPC H01M 8/0485; H01M 8/04753; H01M 2250/20

(57) ABSTRACT

A fuel cell system includes a fuel cell, a first actuator capable of adjusting a first state quantity indicating an internal state of the fuel cell, a second actuator capable of adjusting a second state quantity indicating the internal state of the fuel cell, and a control unit. The control unit is configured to perform a first control and a second control, the first control includes acquiring a present value of the first state quantity and controlling operation of the first actuator so that the acquired present value of the first state quantity approaches a predetermined first target value, and the second control includes acquiring a present value of the second state quantity and controlling operation of the second actuator so that the acquired present value of the second state quantity approaches a predetermined second target value.

### CROSS REFERENCE TO RELATED APPLICATIONS

The present application is a continuation application of International Patent Application No. PCT/JP2023/014093 filed on Apr. 5, 2023, which designated the U.S. and claims the benefit of priority from Japanese Patent Application No. 2022-068496 filed on Apr. 18, 2022. The entire disclosures of all of the above applications are incorporated herein by reference.

### TECHNICAL FIELD

The present disclosure relates to a fuel cell system.

### BACKGROUND

Conventionally, it has been known that voltage fluctuation in a fuel cell can cause deterioration of a power generation performance of a catalyst included in an electrode of the fuel cell.

### SUMMARY

The present disclosure provides a fuel cell system including a fuel cell, a first actuator, a second actuator, and a control unit. The fuel cell includes an electrolyte membrane made of a solid polymer, a fuel electrode disposed on one side of the electrolyte membrane, and an air electrode disposed on another side of the electrolyte membrane. The first actuator is capable of adjusting a first state quantity indicating an internal state of the fuel cell. The second actuator is capable of adjusting a second state quantity different from the first state quantity and indicating the internal state of the fuel cell. The control unit is configured to control operation of the first actuator and operation of the second actuator. The control unit is configured to perform a first control and a second control. The first control includes acquiring a present value of the first state quantity and controlling the operation of the first actuator so as to change the first state quantity in such a manner that the present value of the first state quantity that is acquired approaches a predetermined first target value. The second control includes acquiring a present value of the second state quantity and controlling the operation of the second actuator so as to change the second state quantity in such a manner that the present value of the second state quantity that is acquired approaches a predetermined second target value.

### BRIEF DESCRIPTION OF DRAWINGS

Objects, features and advantages of the present disclosure will become apparent from the following detailed description made with reference to the accompanying drawings. In the drawings:

FIG. 1 is a schematic diagram showing an overall configuration of a fuel cell system of a first embodiment;

FIG. 2 is a schematic diagram showing an internal structure of a fuel cell of the first embodiment;

FIG. 3 is a schematic diagram of a control unit provided in the fuel cell system of the first embodiment;

FIG. 4A is a diagram showing a relationship between an output voltage and an output current of a fuel cell with ideal characteristics;

FIG. 4B is a diagram showing a relationship between an output voltage and an output current of a fuel cell, for explaining an issue to be solved by the present disclosure;

FIG. 5 is a flowchart of a membrane humidity control performed by the control unit in the fuel cell system of the first embodiment;

FIG. 6 is a time chart showing a voltage, a membrane humidity, and the like of a fuel cell in each of the fuel cell system of the first embodiment and a fuel cell system of Comparative Example 1;

FIG. 7 is a flowchart of a start permitting process of a catalytic oxide film ratio control performed by the control unit in the fuel cell system of the first embodiment;

FIG. 8 is a flowchart of the catalytic oxide film ratio control performed by the control unit in the fuel cell system of the first embodiment;

FIG. 9 is a time chart showing a voltage, a catalytic oxide film ratio and the like of a fuel cell in each of the fuel cell system of the first embodiment and a fuel cell system of Comparative Example 2;

FIG. 10 is a flowchart of an operation control performed by the control unit in the fuel cell system of the first embodiment;

FIG. 11 is a flowchart of an intermittent operation process in S36 of FIG. 10;

FIG. 12 is a time chart showing a voltage, a catalytic oxide film ratio and the like of a fuel cell in each of the fuel cell system of the first embodiment and a fuel cell system of Comparative Example 3;

FIG. 13 is a flowchart of a start permitting process of a diffusion resistance control performed by the control unit in the fuel cell system of the first embodiment;

FIG. 14 is a flowchart of the diffusion resistance control performed by the control unit in the fuel cell system of the first embodiment;

FIG. 15 is a time chart showing a voltage, a diffusion resistance, and the like of a fuel cell in each of the fuel cell system of the first embodiment and a fuel cell system of Comparative Example 4; and

FIG. 16 is a time chart showing a voltage, a membrane humidity, and the like of a fuel cell in each of a fuel cell system of a second embodiment and a fuel cell system of Comparative Example 5.

### DETAILED DESCRIPTION

Next, a relevant technology is described only for understanding the following embodiments. In a fuel cell system, a control unit may decrease fluctuation in a target electric power of a fuel cell to restrict actual voltage fluctuation of the fuel cell. Accordingly, it is possible to restrict deterioration of a catalyst performance caused by voltage fluctuation.

However, according to an investigation by the present inventor, variation in an internal state of a fuel cell also causes voltage fluctuation in the fuel cell. This voltage fluctuation deteriorates a power generation performance of a catalyst included in an electrode.

A fuel cell system according to an aspect of the present disclosure includes a fuel cell, a first actuator, a second actuator, and a control unit. The fuel cell includes an electrolyte membrane made of a solid polymer, a fuel electrode disposed on one side of the electrolyte membrane, and an air electrode disposed on another side of the electrolyte membrane. The first actuator is capable of adjusting a first state quantity indicating an internal state of the fuel cell. The second actuator is capable of adjusting a second state quantity different from the first state quantity and indicating the internal state of the fuel cell. The control unit is configured to control operation of the first actuator and operation of the second actuator. The control unit is configured to perform a first control and a second control. The first control includes acquiring a present value of the first state quantity and controlling the operation of the first actuator so as to change the first state quantity in such a manner that the present value of the first state quantity that is acquired approaches a predetermined first target value. The second control includes acquiring a present value of the second state quantity and controlling the operation of the second actuator so as to change the second state quantity in such a manner that the present value of the second state quantity that is acquired approaches a predetermined second target value.

According to the configuration described above, it is possible to restrict voltage fluctuation in the fuel cell caused by variation in the internal state of the fuel cell. Therefore, it is possible to restrict deterioration of a power generation performance of a catalyst included in the air electrode.

Hereinbelow, embodiments of the present disclosure will be described with reference to the drawings. In the following embodiments, the same or equivalent parts are denoted by the same reference numerals.

### First Embodiment

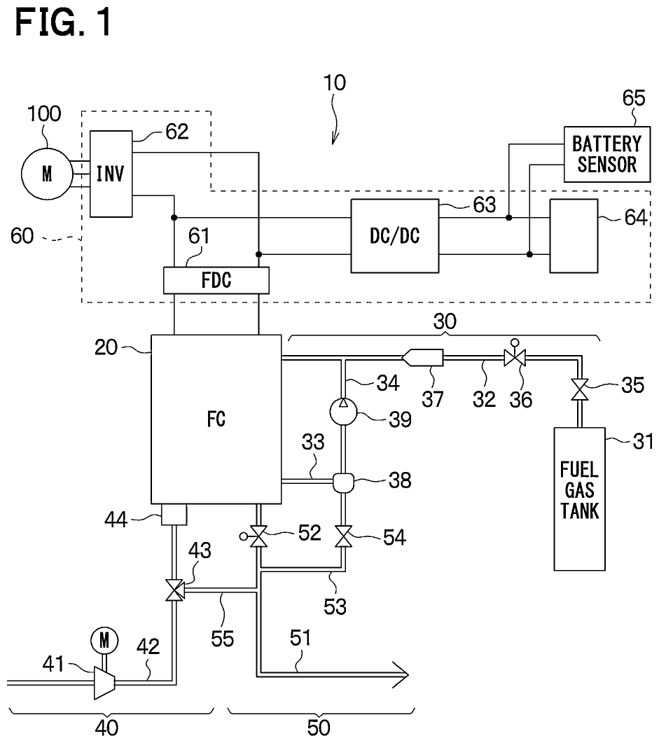

A fuel cell system 10 according to the present embodiment shown in FIG. 1 is mounted on a vehicle as a power source for driving the vehicle. In addition to the fuel cell system 10, a drive motor 100 is also mounted on the vehicle. The fuel cell system 10 includes a fuel cell (that is, FC) 20, a fuel gas supply system 30, an oxidant gas supply system 40, an exhaust gas system 50, and a power circuit 60.

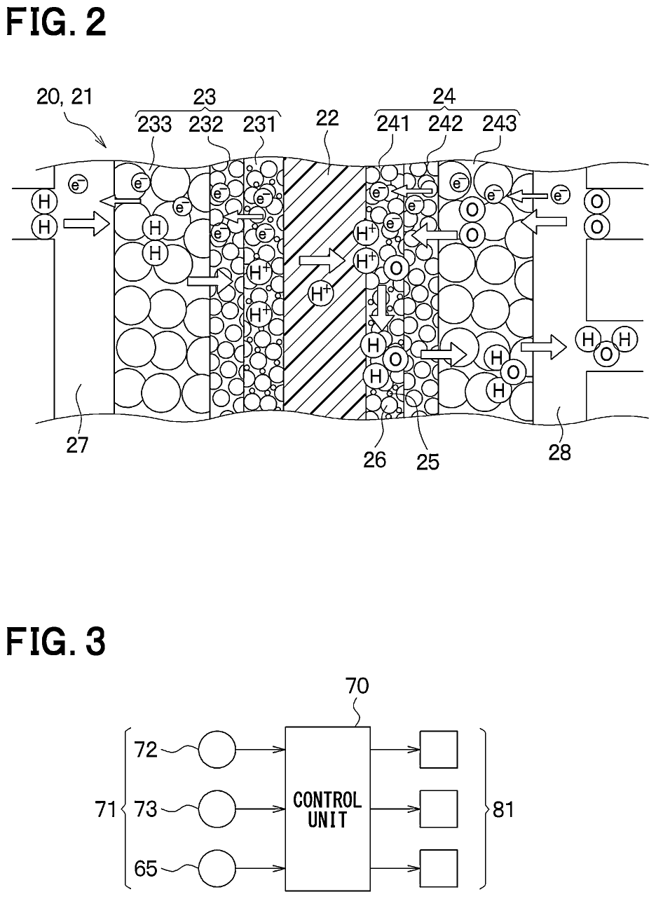

The FC 20 is a polymer electrolyte fuel cell. The FC 20 has a stack configuration in which multiple unit cells 21 shown in FIG. 2 are stacked. The unit cell 21 includes an electrolyte membrane 22 made of a solid polymer, a fuel electrode 23, and an air electrode 24.

The electrolyte membrane 22 is also called a PEM. PEM is an abbreviation for Polymer Electrolyte Membrane. The electrolyte membrane 22 has proton conductivity. The fuel electrode 23 is disposed on one side of the electrolyte membrane 22. The fuel electrode 23 is supplied with hydrogen gas as a fuel gas. The fuel electrode 23 is an anode that emits electrons. The air electrode 24 is disposed on the other side of the electrolyte membrane 22. The air electrode 24 is supplied with air serving as an oxidant gas, that is, oxygen gas. The air electrode 24 is a cathode that accepts electrons.

Each of the fuel electrode 23 and the air electrode 24 has a catalyst layer 231, 241, a water-repellent layer 232, 242, and a gas diffusion layer 233, 243, respectively.

The catalyst layers 231 and 241 are layers containing a catalyst and are also called CLs. CL is an abbreviation for Catalyst Layer. More specifically, the catalyst layers 231, 241 have catalyst particles (for example, Pt particles) 25, support particles 26 that support the Pt particles, and a polymer material such as an ionomer (not shown) that holds the support particles 26 and is responsible for proton conduction.

The water-repellent layers 232 and 242 are layers that transport water to the gas diffusion layers 233 and 243 so as not to condense water. The water-repellent layers 232, 242 are also referred to as MPLs. MPL is an abbreviation for Micro Porous Layer.

The gas diffusion layers 233 and 243 are layers that diffuse gas so that the gas spreads uniformly throughout the catalyst layers 231 and 241. The gas diffusion layers 233, 243 are also called GDLs. GDL is an abbreviation for Gas Diffusion Layer.

A hydrogen gas flow passage 27 through which hydrogen gas flows is formed on a side of the unit cell 21 adjacent to the fuel electrode 23. An air flow passage 28 through which air flows is formed on a side of the unit cell 21 adjacent to the air electrode 24.

Hydrogen gas and air are supplied to the fuel electrode 23 and the air electrode 24, respectively, and the following electrochemical reactions occur as shown in FIG. 2.

(Fuel Electrode)H₂→2H⁺+2 e⁻ (Air Electrode)½O₂+2H⁺+2 e⁻→H₂O

In the present embodiment, the gas diffusion layers 233, 243 and the water-repellent layers 232, 242 are provided separately, but the gas diffusion layers 233, 243 may also function as the water-repellent layers.

The fuel gas supply system 30 shown in FIG. 1 supplies hydrogen gas as a fuel gas to the FC 20. The fuel gas supply system 30 includes a fuel gas tank 31, a hydrogen supply passage 32, a fuel gas discharge passage 33, a circulation passage 34, a main stop valve 35, a regulator 36, an injector 37, a gas-liquid separator 38, and a circulation pump 39.

The fuel gas tank 31 is a storage device for storing hydrogen gas, and is connected to the FC 20 via the hydrogen supply passage 32. The hydrogen supply passage 32 is a flow passage through which hydrogen gas supplied to the FC 20 flows. Hydrogen gas stored in the fuel gas tank 31 is supplied to an anode side flow passage of the FC 20 via the opening and closing of the hydrogen supply passage 32 by the main stop valve 35, pressure reduction by the regulator 36, and discharge from the injector 37.

The fuel gas discharge passage 33 is a passage through which an anode off-gas discharged from the FC 20 flows. The circulation passage 34 is connected to the fuel gas discharge passage 33 and a portion of the hydrogen supply passage 32 downstream of the injector 37. The pressure of hydrogen circulating through the circulation passage 34 is adjusted by the circulation pump 39. The amount of the fuel gas supplied to the FC 20 can be adjusted by driving amounts of the injector 37 and the circulation pump 39. The gas-liquid separator 38 is disposed at a connection portion between the fuel gas discharge passage 33 and the circulation passage 34. The gas-liquid separator 38 separates water and gas in the anode off-gas.

The oxidant gas supply system 40 supplies air as the oxidant gas to the FC 20. The oxidant gas supply system 40 includes an air compressor 41, an air supply passage 42, a flow dividing valve 43, and a humidifier 44.

The air compressor 41 compresses air and supplies the air to a cathode side flow passage of the FC 20 via the air supply passage 42. The air supply passage 42 is a flow passage through which air supplied to the FC 20 flows. The flow dividing valve 43 is disposed at a connection portion of the air supply passage 42 with an air bypass passage 55, which will be described later. The humidifier 44 is disposed on the air supply passage 42 on an air inlet side of the FC 20. The humidifier 44 supplies water to the air electrode 24 of the FC 20.

The exhaust gas system 50 exhausts off-gas from the FC 20 to the outside. The exhaust gas system 50 includes an exhaust gas flow passage 51, a pressure regulating valve 52, a hydrogen discharge passage 53, a purge valve 54, and the air bypass passage 55.

The exhaust gas flow passage 51 is a flow passage through which a cathode off-gas is discharged from the FC 20. The pressure regulating valve 52 is disposed on the exhaust gas flow passage 51 and adjusts the pressure of the air in the FC 20. The hydrogen discharge passage 53 connects the gas-liquid separator 38 and the exhaust gas flow passage 51. The hydrogen discharge passage 53 is provided with the purge valve 54. The purge valve 54 opens to discharge water and gas from the gas-liquid separator 38 when a nitrogen concentration in the anode off-gas becomes high or when the amount of water in the gas-liquid separator 38 becomes large. Hydrogen in the anode off-gas discharged through the purge valve 54 flows through the exhaust gas flow passage 51 and is diluted by the cathode off-gas. The air bypass passage 55 connects the air supply passage 42 and the exhaust gas flow passage 51.

The power circuit 60 is connected to the FC 20. The drive motor 100 and various auxiliary devices (not shown) are connected to the power circuit 60. The power circuit 60 includes an FC boost converter (that is, FDC) 61, an inverter 62, a battery converter 63, a battery 64, and a battery sensor 65.

The FC boost converter 61 is a DC/DC converter that boosts an output voltage of the FC 20 to a high voltage that can be used by the drive motor 100. The inverter 62 converts the direct current voltage boosted by the FC boost converter 61 into an alternating current voltage and supplies the alternating current to the drive motor 100. The drive motor 100 is a motor that drives wheels of the vehicle, and generates regenerative power during deceleration of the vehicle.

The battery converter 63 is a bidirectional DC/DC converter. The battery converter 63 steps down the voltage boosted by the FC boost converter 61 and the voltage generated by the regenerative operation of the drive motor 100, and supplies the step-down voltage to the battery 64. In addition, the battery converter 63 boosts the voltage of the battery 64 and supplies the boosted voltage to the inverter 62.

The battery 64 is a chargeable and dischargeable power storage device. The battery 64 stores the power generated by the FC 20 and the regenerative power from the drive motor 100. The battery 64 supplies the power to loads including the drive motor 100. The battery sensor 65 is connected to the battery 64 and detects a voltage, a current and a state of charge (that is, SOC) of the battery 64. SOC is an abbreviation for State Of Charge.

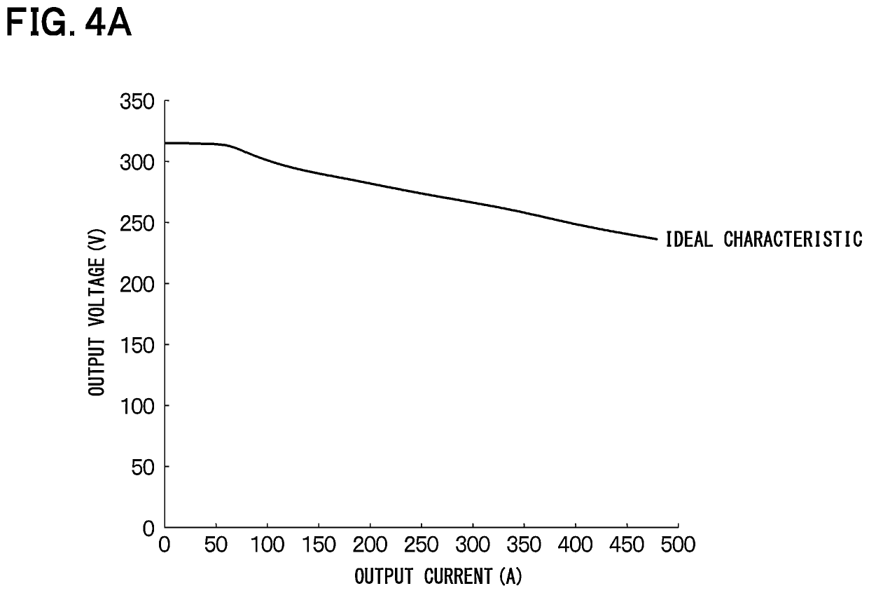

The fuel cell system 10 includes a control unit 70 shown in FIG. 3. The control unit 70 is configured by a microcomputer, and has a CPU, a ROM, a RAM, and an input/output port. The control unit 70 controls the power generation of the fuel cell system 10 and also controls the entire vehicle including the power circuit 60. The ROM and RAM are each a non-transitory tangible storage medium.

The control unit 70 acquires output signals from multiple sensors 71 provided in the vehicle. The multiple sensors 71 include sensors provided in various parts of the fuel cell system 10, an accelerator opening sensor, a shift position sensor, an outside air temperature sensor, and a vehicle speed sensor. The sensors provided in various parts of the fuel cell system 10 include a temperature sensor 72 that detects a temperature of the FC 20, a current sensor 73 that detects a current output by the FC 20, and the battery sensor 65.

The control unit 70 controls the operation of various actuators 81 by outputting drive signals to the various actuators 81 related to power generation, running, and the like of the vehicle. The various actuators 81 include the injector 37, the circulation pump 39, the air compressor 41, the flow dividing valve 43, the FC boost converter 61, and the like.

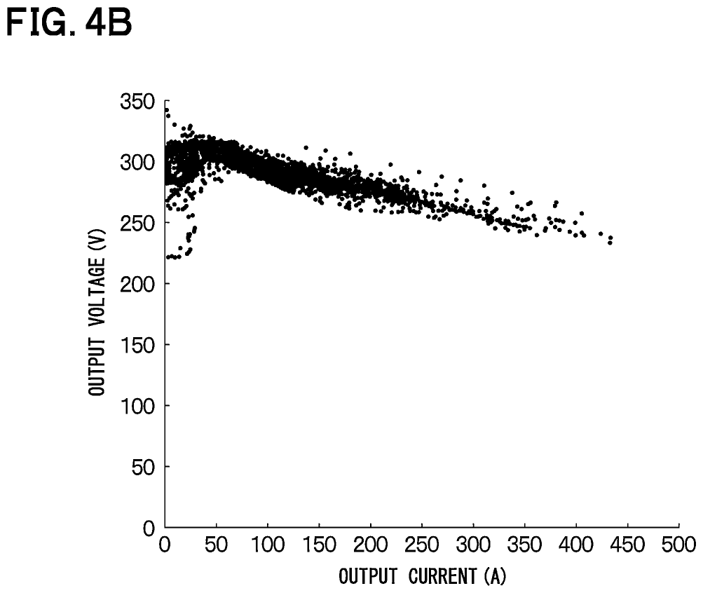

As shown in FIG. 4A, in the ideal characteristic of the FC 20, there is a one-to-one relationship between an output current and an output voltage of the FC 20. However, when the present embodiment is not applied, there is variation in the magnitude of the output voltage of the FC 20 relative to the output current of the FC 20, as shown in FIG. 4B. That is, the output voltage when the output current has a certain value varies. One of the causes of this variation is variation in the internal state of the FC 20.

The internal state of the FC 20 includes a dry and wet state of the electrolyte membrane 22, a formation state of an oxide film covering the catalyst of the air electrode 24, and a gas diffusion state of air (that is, oxygen gas) in the air electrode 24. When a humidity of the electrolyte membrane 22 fluctuates, the output voltage of the FC 20 fluctuates. When a ratio of the oxide film covering the surface area to the surface area of the catalyst of the air electrode 24 fluctuates, the output voltage of the FC 20 fluctuates. When a diffusivity of the air changes due to condensed water formed on the air electrode 24, the output voltage of the FC 20 fluctuates.

When a load is low, such as when the output current of the FC 20 is 100 A or less, a cell voltage becomes a high potential of 0.8 V or more. In the air electrode 24, when the cell voltage is at a high potential, an oxide film (that is, PtO) is formed on a surface of platinum (that is, Pt) particles serving as a catalyst. Furthermore, when the cell voltage is at a high potential, Pt is ionized and dissolved. On the other hand, when the cell voltage is a low potential of 0.6 V or less, the oxide film is reduced and disappears.

If the fluctuation in the output voltage of the FC 20 due to variation in the internal state of the FC 20 is large, the cell voltage becomes low potential and the oxide film of the catalyst disappears, and in this state the cell voltage remains at a high potential for a long time. When the particles coarsen due to repeated dissolution and precipitation, an effective surface area of the catalyst decreases and the power generation performance deteriorates. This promotes decrease in the ECSA of the catalyst due to the elution of Pt, that is, deterioration in the power generation performance. ECSA is an abbreviation for Electrochemically active surface area.

Therefore, in the present embodiment, the control unit 70 detects the internal state of the FC 20 and performs control to make the internal state of the FC 20 a target state.

First, detection of the internal state of the FC 20 will be described. The control unit 70 acquires multiple state quantities indicating the internal state of the FC 20. One of the multiple state quantities is a relative humidity of the electrolyte membrane 22. In the following, the relative humidity of the electrolyte membrane 22 is also called a membrane humidity. Another state quantity among the multiple state quantities is an oxide film ratio of the catalyst of the air electrode 24. Hereinafter, the oxide film ratio of the catalyst of the air electrode 24 is also referred to as a catalytic oxide film ratio. Another state quantity among the multiple state quantities is a gas diffusion resistance of the air electrode 24. Hereinafter, the gas diffusion resistance of the air electrode 24 is also called a diffusion resistance.

### [Calculation of Membrane Humidity]

The control unit 70 calculates σ_{PEMref}, which is an unknown parameter in model formulas, using the model formulas of resistance overvoltage shown in the following mathematical formulas (1-1) to (1-4), the value of the resistance overvoltage, the sensor value, and constants.

$$Δ {V}_{o h m} = Δ {V}_{o h m}^{P E M} + Δ {V}_{o h m}^{G M} \qquad ( 1 ‐ 1 )$$

$$Δ {V}_{o h m}^{P E M} = ( \frac{T {h}_{P E M}}{{σ}_{P E M}} ) \times i \qquad ( 1 ‐ 2 )$$

$$Δ {V}_{o h m}^{G M} = {R}_{G M} \times i \qquad ( 1 ‐ 3 )$$

$${σ}_{PEM} = {C}_{σ}^{T} \times {σ}_{PEMref} \qquad ( 1 ‐ 4 )$$

The symbols in these formulas are as shown in Table 1.

TABLE 1

| SYMBOL | CONTENT | UNIT |
|---|---|---|
| ΔVₒₕₘ | Resistance Overvoltage | V |
| ΔVₒₕₘ^{PEM} | PEM Resistance Overvoltage | V |
| i | FC Current | A/m² |
| σ_{PEM} | PEM Effective H⁺ Conductivity | S/m |
| Th_{PEM} | PEM Thickness | m |
| σ_{PEM} | PEM H⁺ Conductivity at Reference Temperature | S/m |
| | (Humidity Dependence) | |
| C_{σ}^{T} | Temperature Dependence Coefficient of PEM H⁺ | — |
| | Conductivity | |
| ΔVₒₕₘ^{GM} | GPL/MPL Resistance Overvoltage | V |
| R_{GM} | GDL/MPL Resistance | Ohm*m² |

The value of the resistance overvoltage is determined from the impedance. Specifically, it is known that by measuring the alternating current impedance of the FC 20, the values of an ohmic resistance Rₒₕₘ, a reaction resistance R_{act}, and a diffusion resistance R_{gas} that constitute the internal resistance of the FC 20 can be derived. As shown in the following mathematical formula (1-5), there is a certain relationship between a resistance overvoltage ΔVₒₕₘ and the ohmic resistance Rₒₕₘ. That is, the product of the ohmic resistance Rₒₕₘ and the FC current i is the resistance overvoltage ΔVₒₕₘ. Using this relationship, the value of the resistance overvoltage ΔVₒₕₘ can be determined from the derived ohmic resistance Rₒₕₘ.

$$Δ {V}_{o h m} ∝ {R}_{o h m} \qquad ( 1 ‐ 5 )$$

The sensor value is the value of the FC current i measured by the current sensor 73 during FC operation. The values of the constants in the formulas are stored in advance in a storage unit included in the control unit 70. It should be noted that constants that are likely to change due to degradation (for example, PEM thickness, GDL/MPL resistance) tend to change slowly over time. Therefore, values obtained by learning the amount of deterioration from the difference between the detection results of the resistor overvoltage detected under operating conditions in which the membrane humidity and the sensor values are fixed may be used as the values of the constants.

After calculating σ_{PEMref}, the control unit 70 calculates the membrane humidity from σ_{PEMref}. There is a certain relationship between σ_{PEMref} and the membrane humidity. A map showing this relationship is determined by experiment. The map showing this relationship is stored in the storage unit, and the control unit 70 can use the map showing this relationship to determine the membrane humidity from the calculated value of σ_{PEMref}.

After the membrane humidity is known by the above calculation of the membrane humidity, the control unit 70 calculates ECSA, which is an unknown parameter in model formulas using model equations for the cathodic activation overvoltage shown below as mathematical formulas (2-1) and (2-2), the value of the cathodic activation overvoltage, the sensor value, and constant values.

$$Δ {V}_{a c t} = \frac{R T}{{α}_{c f} F} ln ( \frac{i}{{i}_{0}} ) \qquad ( 2 ‐ 1 )$$

$${i}_{0} = {i}_{0}^{ref} \times ECSA \times {C}_{ECSA}^{RH} \times {C}_{{i}_{0}}^{T} \qquad ( 2 ‐ 2 )$$

The symbols in these formulas are as shown in Table 2.

TABLE 2

| SYMBOL | CONTENT | UNIT |
|---|---|---|
| ΔV_{act} | Cathodic Activation Overvoltage | V |
| R | Gas Constant | J/K/mol |
| T | FC Temperature | K |
| i | FC Current | A/m² |
| α_{cf} | Cathode Reaction Charge Transport Coefficient | — |
| | (Forward Reaction) | |
| F | Faraday Constant | J/mol/V |
| i₀^{ref} | Cathode Reaction Reference Exchange Current | A/m²-Pt |
| | Density | |
| ECSA | Electrochemical Surface Area of Cathode Catalyst | m² |
| | Layer | |
| C_{ECSA}^{RH} | Humidity Dependence Coefficient of ECSA | /100% |
| | Temperature Dependence Coefficient of Exchange | — |
| Cᵢ_{₀}^{T} | Current Density | |

The value of the cathodic activation overvoltage is determined from the impedance. As described above, the value of the reaction resistance R_{act} can be derived by measuring the alternating current impedance in the FC 20. As shown in the following mathematical formula (2-3), there is a predetermined relationship between the cathodic activation overvoltage ΔV_{act} and the reaction resistance R_{act}. This predetermined relationship is a relationship under various conditions such as FC current and FC temperature. A map showing this relationship is determined by experiment. The map showing this relationship is stored in the storage unit, and the control unit 70 can use the map showing this relationship to determine the value of the cathodic activation overvoltage ΔV_{act}.

$$Δ {V}_{a c t} ∝ {R}_{a c t} \qquad ( 2 ‐ 3 )$$

The sensor values are the FC present value measured by the current sensor 73 during the FC operation, and the FC temperature value measured by the temperature sensor 72 during the FC operation. The ECSA temperature and humidity dependency coefficient C_{ECSA}^{RH}, is calculated from the membrane humidity using a physical formula or a map. The values of the constants in the formula are stored in advance in the storage unit included in the control unit 70.

After calculating the ECSA, the control unit 70 calculates the catalytic oxide film ratio from the ECSA. The catalytic oxide film ratio is calculated as the ratio of the calculated ECSA value to the initial ECSA value. The ECSA changes reversibly due to the influence of the oxide film, and also changes slowly over time due to deterioration. Therefore, the deterioration amount learned from the difference in the detection results of the activation overvoltage detected under conditions in which there is no oxide film and each parameter is fixed may be used as a learned value instead of the initial value.

### [Calculation of Gas Diffusion Resistance]

After the membrane humidity is known by the calculation of the membrane humidity and the catalytic oxide film ratio is known by the calculation of the catalytic oxide film ratio, the control unit 70 calculates the gas diffusion resistance, which is an unknown parameter in formulas, using model formulas of the cathode concentration overvoltage shown below as mathematical formulas (3-1) to (3-4), the sensor values, and constants.

$$Δ {V}_{c n c} = - γ \frac{R T}{{α}_{c f} F} ln ( \frac{{m}_{{o}_{2}}^{P T}}{{m}_{{o}_{2} ref}} ) \qquad ( 3 ‐ 1 )$$

$${m}_{{o}_{2}}^{P T} = {{m}_{{o}_{2}} ( 1 - \frac{i}{{i}_{lim}} )}^{Agg} \qquad ( 3 ‐ 2 )$$

$${i}_{lim} = \frac{4 F {m}_{{o}_{2}}}{{R}_{{o}_{2}}} \qquad ( 3 ‐ 3 )$$

$${R}_{{o}_{2}} = {C}_{R {o}_{2}}^{R H} \times {C}_{R {o}_{2}}^{ECSA} \times {R}_{{o}_{2} ref} \qquad ( 3 ‐ 4 )$$

The symbols in these formulas are as shown in Table 3.

TABLE 3

| SYMBOL | CONTENT | UNIT |
|---|---|---|
| ΔV_{cnc} | Cathodic Concentration Overvoltage | V |
| γ | Cathodic Reaction Order | — |
| R | Gas Constant | J/K/mol |
| T | FC Temperature | K |
| i | FC Current | A/m² |
| α_{cf} | Cathode Reaction Charge Transport Coefficient | — |
| | (Forward Reaction) | |
| F | Faraday Constant | J/mol/V |
| iₗᵢₘ | Limiting Current Density | — |
| Agg | Agglomerate Coefficient | — |
| | Dependent on Agglomerate Structure and Gas | |
| | Species | |
| mₒ_{₂} | O₂ Molar Concentration in Catalyst Pores | mol/m³ |
| mₒ_{₂}^{PT} | O₂ Molar Concentration on Pt Surface | mol/m³ |
| Rₒ_{₂} | Effective Gas Diffusion Resistance within | 1/(m/sec) |
| | Ionomer | |
| Rₒ_{₂}_{ref} | Reference Gas Diffusion Resistance within | 1/(m/sec) |
| | Ionomer | |
| C_{Ro}_{₂}^{RH} | Humidity Dependence Coefficient of Gas | — |
| | Diffusion Resistance within Ionomer | |
| C_{Ro}_{₂}^{ECSA} | ECSA Dependence Coefficient of Gas Diffusion | — |
| | Resistance within Ionomer | |

The value of the cathodic concentration overvoltage is determined from the impedance. As described above, by measuring the alternating current impedance in the FC 20, the value of the diffusion resistance R_{gas} can be derived. As shown in the following mathematical formula (3-5), there is a predetermined relationship between the cathodic concentration overvoltage ΔV_{cnc} and the diffusion resistance R_{gas}. This predetermined relationship is a relationship under various conditions such as the FC current and the FC temperature. A map showing this relationship is determined by experiment. The map showing this relationship is stored in the storage unit, and the control unit 70 can use the map showing this relationship to determine the value of the cathodic concentration overvoltage ΔV_{cnc}.

$$Δ {V}_{c n c} ∝ {R}_{g a s} \qquad ( 3 ‐ 5 )$$

The sensor values are the value of the FC current during the FC operation measured by the current sensor 73, the value of the FC temperature during the FC operation measured by the temperature sensor 72, and the value of the air flow rate supplied to the FC 20 during the FC operation measured by the flow rate sensor. The catalyst pore O₂ molar concentration mₒ₂ is calculated from the air flow rate using a physical formula or a map. The values of the constants in the formulas are stored in advance in the storage unit included in the control unit 70.

The diffusion resistance changes reversibly due to the influence of condensed water in the air flow passage, and also changes slowly over time due to deterioration caused by mechanical changes in the GDL/MPL. Therefore, the initial and deteriorated diffusion resistance may be learned from the difference in the detection results of concentration overvoltage detected under conditions where there is no effect of condensed water and each parameter is fixed.

Next, the control performed by the control unit 70 to set the internal state of the FC 20 to the target state will be described.

### [Membrane Humidity Control]

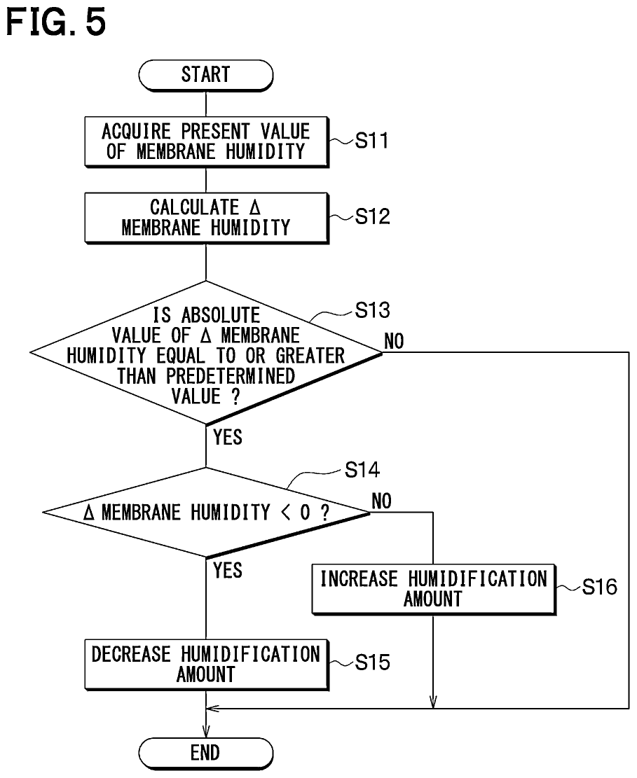

When a system required output is greater than a load operation reference value, a load operation of the fuel cell system 10 is performed. The load operation reference value is a value that is greater than zero and close to zero. During the load operation, the control unit 70 performs a membrane humidity control to make the membrane humidity approach the target value of the membrane humidity. Specifically, the control unit 70 executes a control process shown in FIG. 5. The control process shown in FIG. 5 is repeated until its execution is stopped. The steps shown in FIG. 5 correspond to functional units that realize various functions. This also applies to the other figures.

As shown in FIG. 5, in S11, the control unit 70 acquires a present value of the membrane humidity. At this time, the present value of the membrane humidity is calculated by the above-described calculation method.

Next, in S12, the control unit 70 calculates a Δ membrane humidity, which is a difference between the present value of the membrane humidity and the target value of the membrane humidity, using the present value of membrane humidity acquired in S11 and the target value of the membrane humidity stored in the control unit 70. The target value of the membrane humidity is an ideal value, for example, around 80%.

Subsequently, in S13, the control unit 70 determines whether or not the absolute value of the Δ membrane humidity calculated in S12 is equal to or greater than a predetermined value. If the determination in S13 is NO, the control unit 70 temporarily ends this process. If the determination in S13 is YES, the control unit 70 proceeds to S14.

In S14, the control unit 70 determines whether or not the Δ membrane humidity calculated in S12 is a negative value.

If the present value of the membrane humidity is greater than the target value of the membrane humidity and the Δ membrane humidity is a negative value, the control unit 70 makes a YES determination in S14. In this case, the control unit 70 proceeds to S15 and decreases the humidification amount of the humidifier 44 so as to decrease the membrane humidity. As a result, the membrane humidity changes so that the present value of the membrane humidity approaches the target value of the membrane humidity. Thereafter, the control unit 70 temporarily ends this process.

On the other hand, if the present value of the membrane humidity is smaller than the target value of the membrane humidity and the Δ membrane humidity is a positive value, the control unit 70 makes a NO determination in S14. In this case, the control unit 70 proceeds to S16 and increases the humidification amount of the humidifier 44 so as to increase the membrane humidity. As a result, the membrane humidity changes so that the present value of the membrane humidity approaches the target value of the membrane humidity. Thereafter, the control unit 70 temporarily ends this process.

In this manner, the control unit 70 acquires the present value of the membrane humidity. The control unit 70 controls the operation of the humidifier 44 so as to change the membrane humidity so that the present value of the membrane humidity that is acquired approaches a predetermined target value of the membrane humidity. In the present embodiment, the membrane humidity corresponds to a first state quantity. The target value of the membrane humidity corresponds to a first target value. The humidifier 44 corresponds to a first actuator capable of adjusting the first state quantity. The above-described control of the operation of the humidifier 44 corresponds to a first control.

Here, the present embodiment and Comparative Example 1 are compared. In Comparative Example 1, when the control unit 70 determines that the electrolyte membrane 22 is in an over-dry state based on the operating conditions of the FC 20, the control unit 70 performs control to increase the membrane humidity, for example by increasing an air pressure in the air electrode 24.

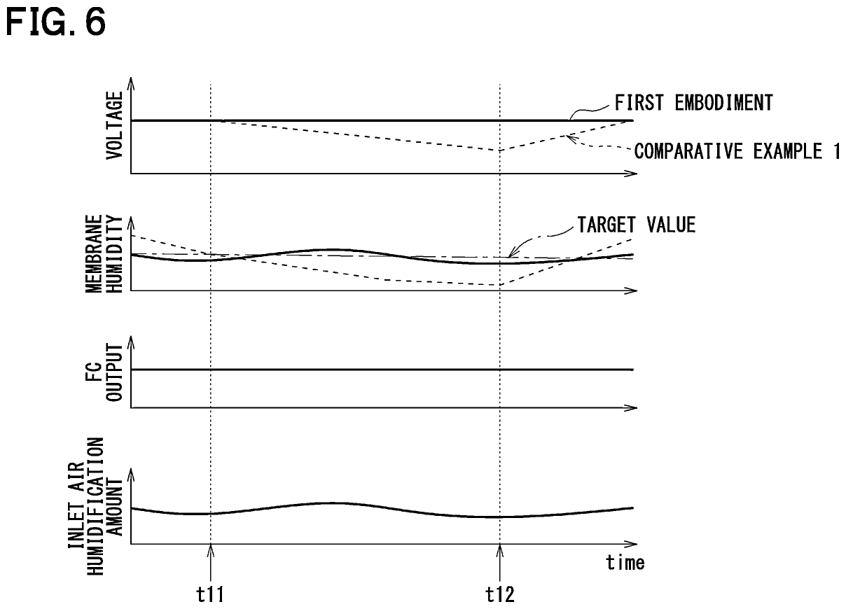

In this case, as shown by a wavy line in FIG. 6, the membrane humidity decreases with time from time t11 to time t12, and the voltage of the FC 20 decreases with time. Time t12 is a time when it is determined to be the over-dry state. After time t12, the membrane humidity increases with time, and the voltage of the FC 20 increases with time. Therefore, as can be seen by comparing the voltage values of the FC 20 at time t11 and time t12, the fluctuation range of the voltage of the FC 20 is large.

In contrast, in the present embodiment, the control unit 70 performs the membrane humidity control described above. In this case, as shown in FIG. 6, the amount of humidification of an inlet air of the air electrode 24 of the FC 20 is adjusted. As a result, the membrane humidity is maintained at a value close to the target value of the membrane humidity, as shown by a solid line in FIG. 6. Therefore, the voltage of the FC 20 fluctuates as shown by the solid line in FIG. 6. Therefore, according to the present embodiment, the fluctuation range of the voltage of the FC 20 can be made smaller than that of Comparative Example 1.

In this manner, according to the present embodiment, the membrane humidity is controlled so as to approach the target value. This makes it possible to decrease the voltage fluctuation caused by variation in the membrane humidity. As a result, deterioration of the power generation performance of the catalyst included in the air electrode 24 can be restricted.

As an actuator capable of adjusting the membrane humidity, the air compressor 41 and the pressure regulating valve 52 may be used in addition to the humidifier 44. The membrane humidity can be adjusted by adjusting the air flow rate using the air compressor 41 and the pressure regulating valve 52. The pressure regulating valve 52 can adjust the air pressure to thereby adjust the membrane humidity. When the air pressure increases, the air flow rate decreases and the membrane humidity is less likely to decrease. When the air pressure decreases, the air flow rate increases and the membrane humidity decreases. During the load operation of the FC 20, in order to supply the FC 20 with the amount of air necessary for power generation, it is preferable to use the humidifier 44 and the pressure regulating valve 52 as actuators capable of adjusting the membrane humidity.

### [Catalytic Oxide Film Ratio Control]

During the load operation, the control unit 70 adjusts the output of the FC 20 (that is, an FC output) according to the magnitude of the system required output. In addition, the control unit 70 performs a catalytic oxide film ratio control to bring the catalytic oxide film ratio closer to a target value of the catalytic oxide film ratio.

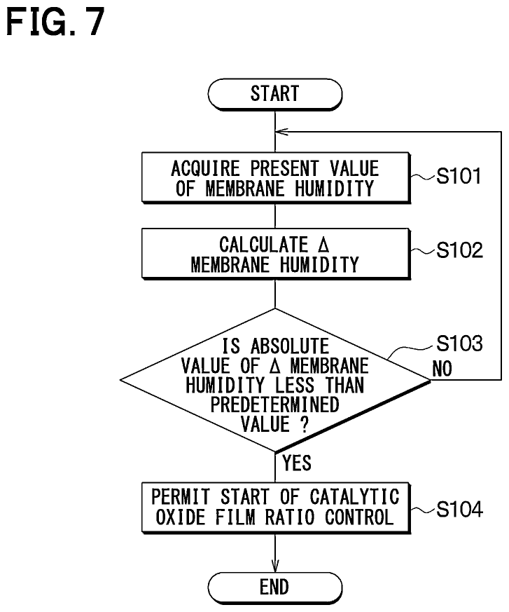

In the present embodiment, the control unit 70 performs a process shown in FIG. 7 before performing the catalytic oxide film ratio control. In S101, similarly to S11 in FIG. 5, the control unit 70 acquires the present value of the membrane humidity. Subsequently, in S102, similarly to S12 in FIG. 5, the control unit 70 calculates the A membrane humidity.

Subsequently, in S103, the control unit 70 determines whether or not the absolute value of the calculated A membrane humidity is less than the predetermined value. At this time, if the membrane humidity control has already been performed, the humidity will be less than the predetermined value, so the control unit 70 makes a YES determination and proceeds to S104. If the membrane humidity control has not been performed, the humidity will not become less than the predetermined value, so the control unit 70 makes a NO determination and returns to S101.

In S104, the control unit 70 permits the start of the catalytic oxide film ratio control. When the start of the catalytic oxide film ratio control is permitted, the control unit 70 performs the catalytic oxide film ratio control. That is, the control unit 70 performs the membrane humidity control and then performs the catalytic oxide film ratio control.

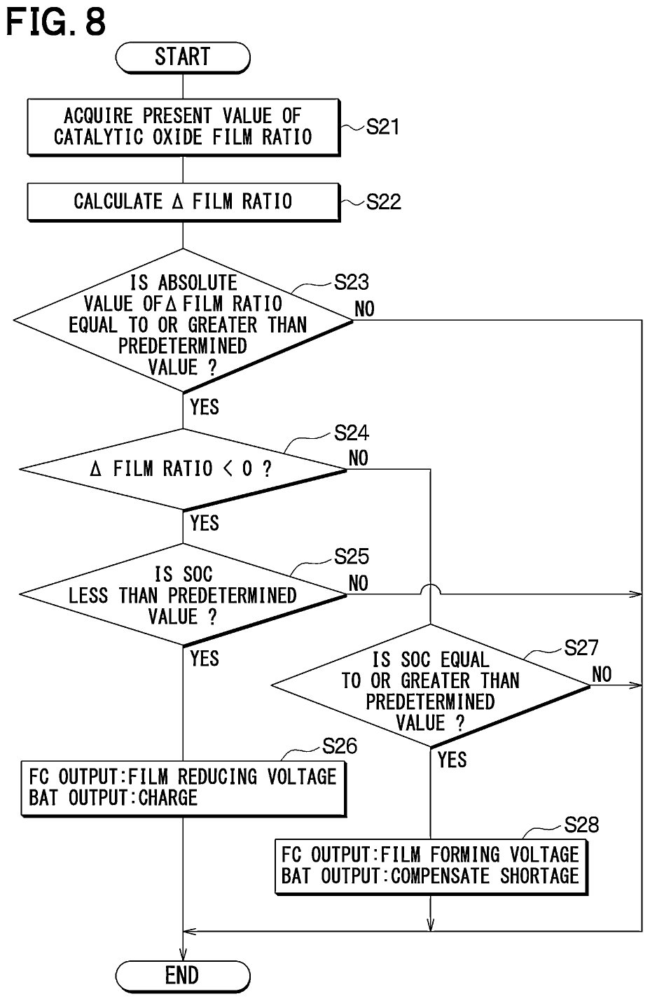

In the catalytic oxide film ratio control, the control unit 70 executes a control process shown in FIG. 8. The control process shown in FIG. 8 is repeated until its execution is stopped.

As shown in FIG. 8, in S21, the control unit 70 acquires the present value of the catalytic oxide film ratio. At this time, the present value of the catalytic oxide film ratio is calculated by the above-described calculation method. The control process shown in FIG. 8 is repeated at predetermined intervals, so that the present value of the catalytic oxide film ratio is acquired periodically (for example, every 1 second).

Next, in S22, the control unit 70 calculates a Δ film ratio, which is the difference between the present value of the catalytic oxide film ratio and the target value of the catalytic oxide film ratio stored in the control unit 70, using the present value of the catalytic oxide film ratio calculated in S21 and the target value of the catalytic oxide film ratio stored in the control unit 70.

Subsequently, in S23, the control unit 70 determines whether or not the absolute value of the A film ratio calculated in S22 is equal to or greater than a predetermined value. If the determination in S23 is NO, the control unit 70 temporarily ends this process. If the determination in S23 is YES, the control unit 70 proceeds to S24.

In S24, the control unit 70 determines whether or not the A film ratio calculated in S22 is a negative value.

In S24, if the present value of the catalytic oxide film ratio is greater than the target value of the catalytic oxide film ratio and the A film ratio is a negative value, the control unit 70 makes a YES determination. In this case, the control unit 70 proceeds to S25, and determines whether the SOC of the battery 64 is less than a predetermined value. If the determination is NO, the control unit 70 temporarily ends this process. If the determination is YES, the control unit 70 proceeds to S26, where the control unit 70 corrects the output of the FC 20 (that is, the FC output) so that the voltage of the FC 20 becomes a film reducing voltage, and corrects the output of the battery 64 (that is, a BAT output) so that the battery 64 is in a charged state.

The film reducing voltage is a voltage at which the catalytic oxide film is decreased by reduction, and is, for example, a cell voltage lower than 0.7 V. Correcting the FC output so as to be the film reduction voltage means increasing the FC output. In order to increase the FC output, the control unit 70 controls the operation of the injector 37, the circulation pump 39, the air compressor 41, the flow dividing valve 43, and the FC boost converter 61 so that a current command from the FC boost converter 61 increases and supply amounts of hydrogen gas and air increase. As a result, the catalytic oxide film ratio changes in such a manner that the present value of the catalytic oxide film ratio approaches the target value of the catalytic oxide film ratio.

Furthermore, the control unit 70 controls the operation of the battery converter 63 so that a surplus of the FC output relative to the system required output is charged to the battery 64. Thereafter, the control unit 70 temporarily ends this process.

In addition, in S24, if the present value of the catalytic oxide film ratio is smaller than the target value of the catalytic oxide film ratio and the A film ratio is a positive value, the control unit 70 makes a NO determination. In this case, the control unit 70 proceeds to S27 and determines whether or not the SOC of the battery 64 is equal to or higher than the predetermined value. If the determination is NO, the control unit 70 temporarily ends this process. If the determination is YES, the control unit 70 proceeds to S28, where the control unit 70 corrects the FC output so that the voltage of the FC 20 becomes a film forming voltage, and corrects the BAT output so that the BAT output becomes a shortage compensating output.

The film forming voltage is a voltage at which the catalytic oxide film is formed, and is, for example, a cell voltage higher than 0.8 V. Correcting the FC output so as to be the film forming voltage means increasing the FC output. In order to decrease the FC output, the control unit 70 controls the operation of the injector 37, the circulation pump 39, the air compressor 41, the flow dividing valve 43, and the FC boost converter 61 so that the current command from the FC boost converter 61 becomes smaller and the supply amounts of hydrogen gas and air are decreased. As a result, the catalytic oxide film ratio changes in such a manner that the present value of the catalytic oxide film ratio approaches the target value of the catalytic oxide film ratio.

The shortage compensating output is an output that compensates for the shortage of the FC output relative to the system required output. The control unit 70 controls the operation of the battery converter 63 so as to cause the battery 64 to output electric power of an amount sufficient to compensate the shortage relative to the system required output. Thereafter, the control unit 70 temporarily ends this process.

In this manner, the control unit 70 acquires the present value of the catalytic oxide film ratio. The control unit 70 controls the operation of the injector 37, the circulation pump 39, the air compressor 41, the flow dividing valve 43, and the FC boost converter 61 so as to change the catalytic oxide film ratio in such a manner that the present value of the catalytic oxide film ratio that is acquired approaches the predetermined target value of the catalytic oxide film ratio. In the present embodiment, the catalytic oxide film ratio corresponds to a second state quantity. The target value of the catalytic oxide film ratio corresponds to a second target value. The injector 37, the circulation pump 39, the air compressor 41, the flow dividing valve 43, and the FC boost converter 61 correspond to second actuators capable of adjusting the second state quantity. The control of the operation of the injector 37 and the like corresponds to a second control.

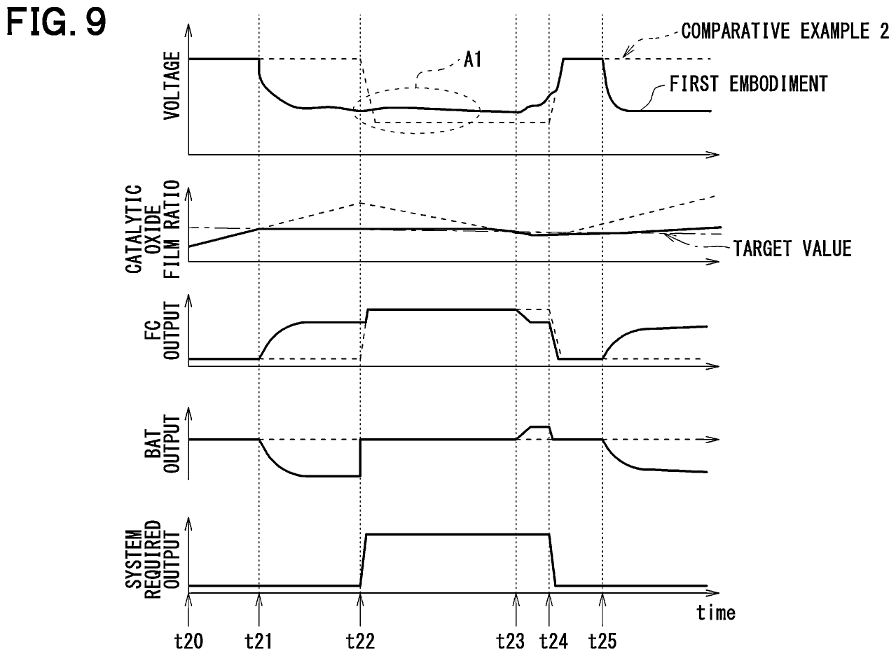

Here, the present embodiment and Comparative Example 2 are compared. In the time chart of FIG. 9, dashed lines indicate Comparative Example 2, and solid lines indicate the present embodiment. A period from time t20 to time t22 is a low load period in which the system required output is lower than a high load reference value. A period from time t22 to time t24 is a high load period in which the system required output is higher than the high load reference value. A period after time t24 is the low load period.

In Comparative Example 2, as shown in FIG. 9, during the low load period from time t20 to time t22, the control unit 70 sets the FC output to a low output value in accordance with the system required output. During the high load period from time t22 to time t24, the control unit 70 sets the FC output to a high output value in accordance with the system required output. During the low load period after time t24, the control unit 70 sets the FC output to a low output value in accordance with the system required output.

In Comparative Example 2, when the load is low, the FC output is low and the cell potential becomes a high potential that is higher than 0.8 V. Thus, the oxide film on the catalyst increases, and as shown in FIG. 9, the catalytic oxide film ratio increases over time. In Comparative Example 2, when the load is high, the FC output is high and the cell potential becomes a low potential that is lower than 0.7 V. Therefore, the oxide film on the catalyst is decreased by reduction, and the catalytic oxide film ratio decreases over time. In Comparative Example 2, when the load is switched from low to high, the FC outputs the desired power in a state where the oxide film on the catalyst is increased, so the voltage drops significantly. Therefore, as shown in FIG. 9, the difference in voltage between the low load period and the high load period is large, that is, the voltage fluctuation range is large.

In the present embodiment, as shown in the period from time t20 to t21 in FIG. 9, basically, similar to Comparative Example 2, during the low load period, the control unit 70 sets the FC output to a low output value in accordance with the system required output. When the present value of the catalytic oxide film ratio exceeds the target value and the battery 64 is in a chargeable state, the control unit 70 performs S26 in FIG. 8 in the catalytic oxide film ratio control. As a result, during the period from time t21 to time t22 in FIG. 9, the control unit 70 increases the FC output so that the voltage of the FC 20 becomes the film reducing voltage, and charges the battery 64 with the surplus FC output at that time.

Then, at the time t22 in FIG. 9 when the load changes from low to high, the control unit 70 increases the FC output, which is on the lower voltage side, to set the FC output to a high output value in accordance with the system required output. At this time, the control unit 70 stops charging the battery 64 with the surplus FC output.

When the present value of the catalytic oxide film ratio falls below the target value during the high load period and the battery 64 is in a state capable of outputting power, the control unit 70 performs S28 in FIG. 8 in the catalytic oxide film ratio control. As a result, during the period from time t23 to time t24 in FIG. 9, the control unit 70 decreases the FC output so that the voltage of the FC 20 becomes the film generating voltage, and increases the output of the battery 64 to compensate for the power deficiency at that time.

Then, at the time t24 in FIG. 9 when the load changes from high to low, the control unit 70 decreases the FC output, which is on the higher voltage side, to set the FC output to a low output value in accordance with the system required output, and stops the output from the battery 64. After that, at time t25 in FIG. 9, the same process as at time t21 is performed.

As described above, according to the present embodiment, the catalytic oxide film ratio can be made lower than that of Comparative Example 2 during the period from time t21 to time t22 in the low load period. Since the load is switched from low to high in this state, the power generation efficiency in the high load period can be increased compared to Comparative Example 2. As a result, as shown in area A1 in FIG. 9, when compared at the same magnitude of the FC output, the voltage of the FC 20 in the high load period can be increased compared to Comparative Example 2. Therefore, compared to Comparative Example 2, the difference in voltage between the low load period and the high load period can be made smaller. In other words, the voltage fluctuation range can be decreased.

In this manner, according to the present embodiment, the catalytic oxide film ratio is controlled so as to approach the target value. Therefore, the voltage fluctuation caused by the variation in the catalytic oxide film ratio can be decreased. As a result, deterioration of the power generation performance of the catalyst included in the air electrode 24 can be restricted.

Furthermore, according to the present embodiment, the control unit 70 performs the membrane humidity control and then performs the catalytic oxide film ratio control. When the membrane humidity is low, the detection accuracy of the catalytic oxide film ratio is low. During the catalytic oxide film ratio control, the control unit 70 detects the catalytic oxide film ratio when the membrane humidity is close to the target value. Therefore, the accuracy of detecting the catalytic oxide film ratio can be improved.

### [Intermittent Operation Process]

The control unit 70 further performs intermittent operation of the fuel cell system 10 when the system required output is smaller than the load operation reference value and power supply from the FC 20 is not required. For example, when the accelerator is off and the system required output is zero, the intermittent operation is performed. The intermittent operation is operation in which air supply to the FC 20 is performed intermittently. The intermittent operation is operation in which the FC 20 generates power while restricting the FC output low in order to maintain the voltage of the FC 20 at a predetermined level. The intermittent operation is not limited to an operation mode in which a small amount of power generation is continued while limiting the power generation, but may be an operation mode in which power generation by the FC 20 is completely stopped.

Here, unlike the present embodiment, when the system required output is smaller than the load operation reference value, the supply of hydrogen gas and air to the FC 20 is stopped, and power generation by the FC 20 is stopped. If the system required output becomes greater than the load operation reference value from this state, start-up operation is necessary, and it takes time to transition to the load operation. Therefore, in the present embodiment, when the system required output is smaller than the load operation reference value, the intermittent operation is performed. This makes it possible to switch to the load operation without performing the start-up operation when the system required output switches from 0 to a state greater than the load operation reference value.

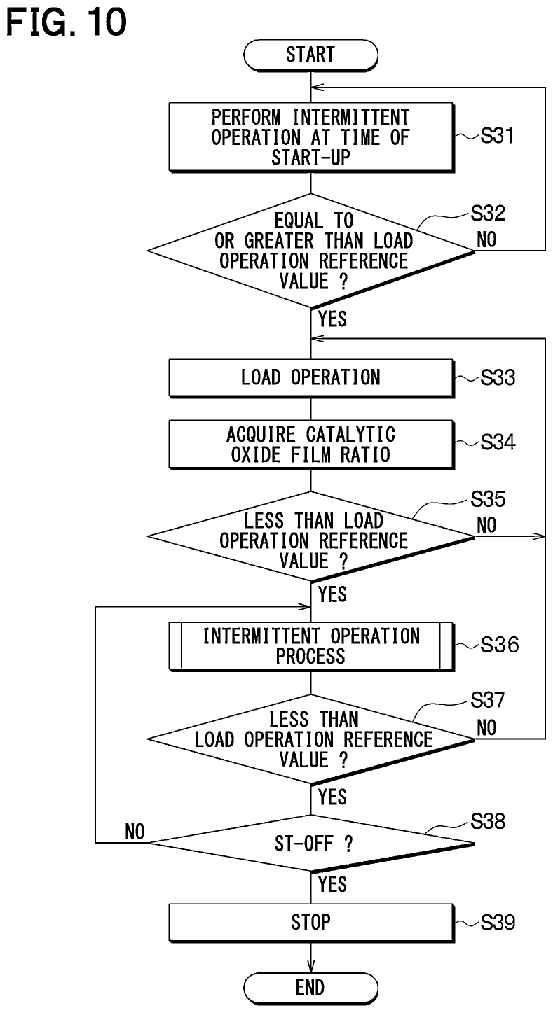

When a start switch ST is turned ON, the control unit 70 starts a control process shown in FIG. 10. First, in S31, the control unit 70 performs the intermittent operation at the time of start-up. When performing the intermittent operation, the control unit 70 controls the operation of the air compressor 41 so that supply and stop of air to the FC 20 are alternately repeated. The control unit 70 controls the operation of the injector 37 and the like so that hydrogen gas is continuously supplied with a minimum amount of hydrogen gas consumption.

Next, in S32, the control unit 70 determines whether or not the system required output is equal to or greater than the load operation reference value. If the determination is NO, the control unit 70 returns to S31 and continues the intermittent operation at the time of start-up. If the determination is YES, the control unit 70 proceeds to S33 and performs the load operation. During the load operation, the control unit 70 controls the operation of the injector 37, the air compressor 41, and the like so that the FC output becomes an output value in accordance with the system required output.

Next, in S34, the control unit 70 acquires the catalytic oxide film ratio during the load operation. At this time, the catalytic oxide film ratio is calculated by the above-described calculation method.

Next, in S35, the control unit 70 determines whether or not the system required output is less than the load operation reference value. If the determination is NO, the control unit 70 returns to S33 and continues the load operation. Thus, when the system required output is equal to or greater than the load operation reference value, the load operation is continued and the catalytic oxide film ratio is periodically acquired.

If the determination in S35 is YES, the control unit 70 proceeds to S36 and performs the intermittent operation process.

After performing the intermittent operation process, the control unit 70 proceeds to S37 and determines whether or not the system required output is less than the load operation reference value. If the determination is NO, the control unit 70 proceeds to S33 and performs the load operation. As a result, if the required output increases during the intermittent operation, the operation is switched from the intermittent operation to the load operation.

If the determination in S37 is YES, the control unit 70 proceeds to S38 and determines whether or not the start switch ST is OFF. If the determination in S38 is NO, the control unit 70 returns to S36 and performs the intermittent operation process. If the determination in S38 is YES, the control unit 70 proceeds to S39 and stops the operation of the fuel cell system 10.

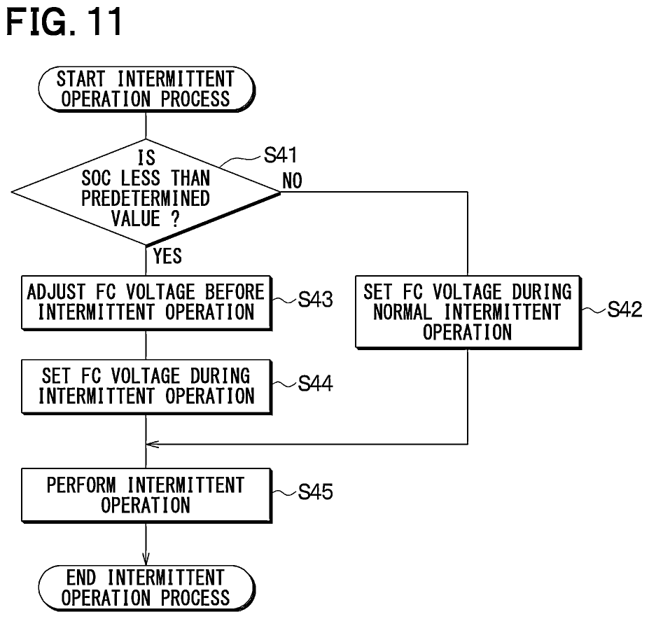

Next, the intermittent operation process in S36 will be described. First, in S41 of FIG. 11, the control unit 70 determines whether or not the SOC of the battery 64 is less than a predetermined value. That is, the control unit 70 determines whether or not the battery 64 is in a chargeable state.

In S41, if the SOC is equal to or greater than the predetermined value and the battery 64 is in an un-chargeable state, the control unit 70 makes a NO determination and proceeds to S42. In S42, the control unit 70 sets the FC voltage during the normal intermittent operation. Thereafter, the control unit 70 proceeds to S45.

In S41, if the SOC is less than the predetermined value and the battery 64 is in the chargeable state, the control unit 70 makes a YES determination and proceeds to S43. In S43, the control unit 70 adjusts the FC voltage before the intermittent operation. After the FC voltage adjustment is completed, the control unit 70 proceeds to S44. In S44, the control unit 70 sets the FC voltage during the intermittent operation. Thereafter, the control unit 70 proceeds to S45.

In S45, the control unit 70 performs the intermittent operation. That is, the control unit 70 controls the operation of the air compressor 41 and the flow dividing valve 43 so that a state in which the air flow rate is 0 and a state where the air flow rate is a predetermined value greater than 0 are alternately repeated. At this time, the control unit 70 adjusts the flow rate of air supplied to the FC 20 so as to achieve the FC voltage set in S42 or S44. After performing the intermittent operation, the control unit 70 ends the intermittent operation process.

Here, the present embodiment will be compared with Comparative Example 3. In Comparative Example 3, the intermittent operation process performed in S36 of the control process in FIG. 10 is different from the present embodiment. In Comparative Example 3, S34 in the control process of FIG. 10 is not performed. The other parts of the control process in FIG. 10 are the same as those in the first embodiment.

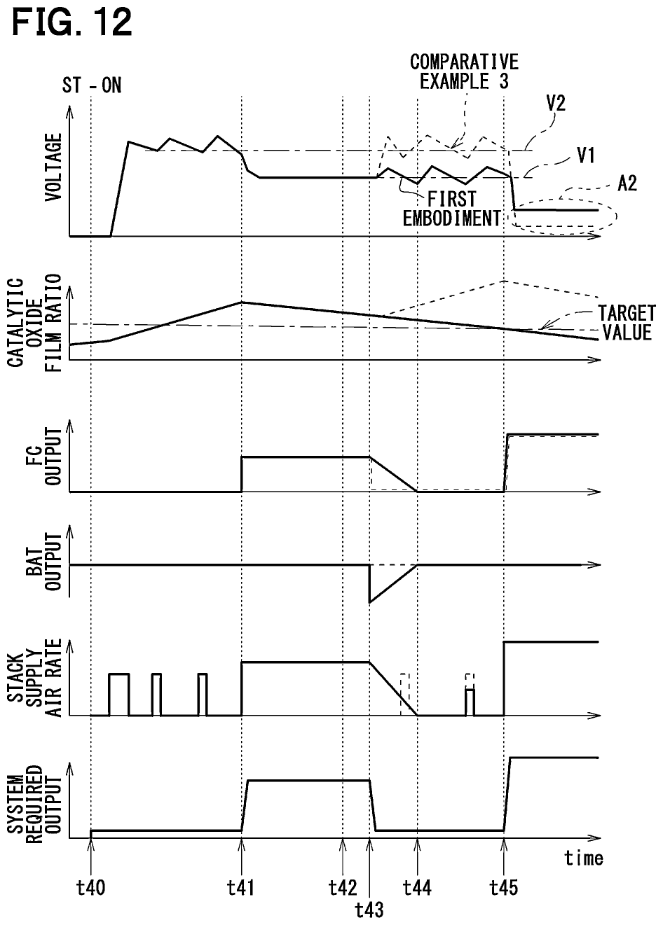

In the time chart of FIG. 12, dashed lines indicate Comparative Example 3, and solid lines indicate the present embodiment. FIG. 12 shows an example in which the system required output is lower than the load operation reference value at the beginning of operation of the fuel cell system 10. An initial period of operation is a predetermined period of time that begins immediately after the start switch ST is turned ON and the operation of the fuel cell system 10 is started. At time t40, the start switch ST is turned ON. A period from time t40 to time t41 is the initial period of operation. In the initial period of operation, the system required output is 0 or close to 0, which is lower than the load operation reference value.

In both the present embodiment and Comparative Example 3, after time t40, the control unit 70 executes S31, thereby performing the intermittent operation at start-up. That is, a state in which the air flow rate supplied to the FC 20 (that is, a stack supply air flow rate) is a predetermined value greater than 0 and a state in which the air flow rate supplied to the FC 20 is 0 are alternately repeated. During the intermittent operation at start-up, the average voltage V2 is high and the cell voltage is at a high potential of 0.7 V to 0.8 V. As a result, the oxide film on the catalyst increases over time, and the catalytic oxide film ratio increases.

After time t41, when the system required output becomes higher than the load operation reference value, in both the present embodiment and Comparative Example 3, the control unit 70 executes S32 and S33 to perform the load operation. Air is supplied continuously, and the FC output is set to an output value in accordance with the system required output.

After time t43, when the system required output becomes lower than the load operation reference value, in Comparative Example 3, the control unit 70 executes S36 to perform intermittent operation after the load operation. In this intermittent operation after the load operation, the supply of air is stopped and the FC output is set to 0. Thereafter, in the same manner as in the intermittent operation at start-up, a state in which the air flow rate is the predetermined value greater than 0 and a state in which the air flow rate is 0 are alternately repeated.

After time t45, when the system required output becomes higher than the load operation reference value, in Comparative Example 3, the control unit 70 executes S37 and S33 to perform the load operation. That is, air is continuously supplied at a flow rate in accordance with the system required output. The FC output is set to an output value in accordance with the system required output.

In this way, in Comparative Example 3, when the system required output switches from a value higher than the load operation reference value to a value lower than the load operation reference value, the FC output is immediately set to 0 and the intermittent operation is performed. When the FC output drops suddenly, the inside of the FC 20 is in a rich state with both hydrogen gas and air, so the voltage of the FC 20 rises suddenly and the cell voltage becomes a high potential of 0.7 V to 0.8 V. For this reason, during the intermittent operation, the catalytic oxide film ratio increases over time. Thereafter, the system required output is switched from a value lower than the load operation reference value to a value higher than the load operation reference value, and the load operation is performed. At this time, since the load operation is performed with the catalytic oxide film ratio being high, the voltage of the FC 20 drops significantly. For this reason, there is a large difference in voltage between when the system required output is lower than the load operation reference value and when the system required output is higher than the load operation reference value. That is, the voltage fluctuation range is large.

In the present embodiment, unlike Comparative Example 3, during the load operation at time t42 and the like, the control unit 70 periodically acquires the catalytic oxide film ratio by executing S34. After time t43, when the system required output becomes lower than the load operation reference value, the control unit 70 performs the intermittent operation process in S36. In this intermittent operation process, if the battery 64 is in a chargeable state, the control unit 70 executes S43 to adjust the FC voltage before the intermittent operation.

In adjusting the FC voltage before the intermittent operation, the control unit 70 compares the present value of the catalytic oxide film ratio acquired in S34 with the target value of the catalytic oxide film ratio, and adjusts the FC output and the air flow rate in accordance with the difference between the present value and the target value so that the FC voltage becomes the target voltage. The target voltage is the voltage at which the oxide film is reduced, that is, a cell potential lower than 0.7 V. The lower the cell potential is from 0.7 V, the faster the reduction occurs.

Specifically, if the present value of the catalytic oxide film ratio is greater than the target value, the control unit 70 gradually decreases the FC output so that the voltage becomes a value at which the catalytic oxide film is reduced, and charges the battery 64 with the surplus FC output. The FC output can be gradually decreased by gradually decreasing the hydrogen gas flow rate and air flow rate supplied to the FC 20 and by decreasing the current command from the FC boost converter 61. The flow rate of hydrogen gas is adjusted by the injector 37 and the circulation pump 39. The air flow rate is adjusted by the air compressor 41 and the flow dividing valve 43.

By gradually decreasing the FC output, a sudden rise in voltage can be restricted. A gradual decrease in air flow rate leads to an air shortage inside the FC 20, which deteriorates the IV performance. By deliberately deteriorating the IV performance, it is possible to restrict the voltage from becoming excessive.

At time t44, when the FC output becomes 0 and the adjustment of the FC voltage is completed, the control unit 70 sets the FC voltage for the intermittent operation in S44. At this time, the air flow rate during the intermittent operation is set to be smaller than the air flow rate during the intermittent operation at start-up so that the average voltage V1 during the intermittent operation is maintained at the voltage during the FC voltage adjustment.

After time t44, the control unit 70 executes S45, thereby performing the intermittent operation. That is, a state in which the air flow rate is 0 and a state in which the air flow rate is the predetermined value are alternately repeated. As described above, the predetermined value of the air flow rate at this time is smaller than the air flow rate in the intermittent operation at start-up. Incidentally, the control unit 70 may adjust the timing of air supply as necessary so that the average voltage during the intermittent operation is maintained at the voltage during the FC voltage adjustment.

Thereafter, after time t45, when the system required output becomes greater than the load operation reference value, the load operation is performed as in Comparative Example 3.

Thus, in the present embodiment, when the system required output switches from a value higher than the load operation reference value to a value lower than the load operation reference value, the FC output is gradually decreased to zero, and then the intermittent operation is performed. By gradually decreasing the FC output, the cell potential becomes a low potential lower than 0.7 V. In this intermittent operation, the air flow rate is decreased compared to the intermittent operation at start-up, so that the cell potential is maintained at the low potential. Accordingly, the oxide film on the catalyst is reduced and the catalytic oxide film ratio is decreased.

Thereafter, the system required output is switched from a value lower than the load operation reference value to a value higher than the load operation reference value, and the load operation is performed. At this time, the load operation is performed in a state where the catalytic oxide film ratio is low, so that the power generation efficiency in the high load period can be improved compared to Comparative Example 3. As a result, as shown in area A2 in FIG. 12, when compared at the same magnitude of the FC output, the voltage of the FC 20 can be made higher than in Comparative Example 3. Therefore, compared to Comparative Example 3, the voltage difference between the intermittent operation at start-up and the load operation can be decreased. In other words, the voltage fluctuation range can be decreased. As a result, deterioration of the power generation performance of the catalyst included in the air electrode 24 can be restricted.

### [Diffusion Resistance Control]

The control unit 70 performs a diffusion resistance control to bring the diffusion resistance closer to a target value of the diffusion resistance during the power generation by the FC 20 such as during the load operation.

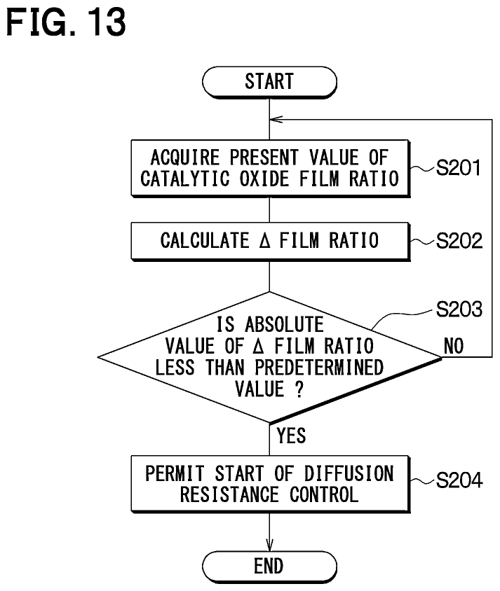

In the present embodiment, the control unit 70 performs a process shown in FIG. 13 before performing the diffusion resistance control. In S201, similarly to S21 in FIG. 8, the control unit 70 acquires the present value of the catalytic oxide film ratio. Subsequently, in S202, the A film ratio is calculated in the same manner as in S22 of FIG. 8.

Subsequently, in S203, the control unit 70 determines whether or not the absolute value of the A film ratio that is calculated is less than the predetermined value. At this time, if the catalytic oxide film ratio control has already been performed, the catalytic oxide film ratio will be less than the predetermined value, so the control unit 70 makes a YES determination and proceeds to S204. If the catalytic oxide film ratio control has not been performed, the catalytic oxide film ratio will not become less than the predetermined value, so the control unit 70 makes a NO determination and returns to S201.

In S204, the control unit 70 permits the start of the diffusion resistance control. When the start of the diffusion resistance control is permitted, the control unit 70 performs the diffusion resistance control. That is, the control unit 70 performs the diffusion resistance control after performing the film ratio control.

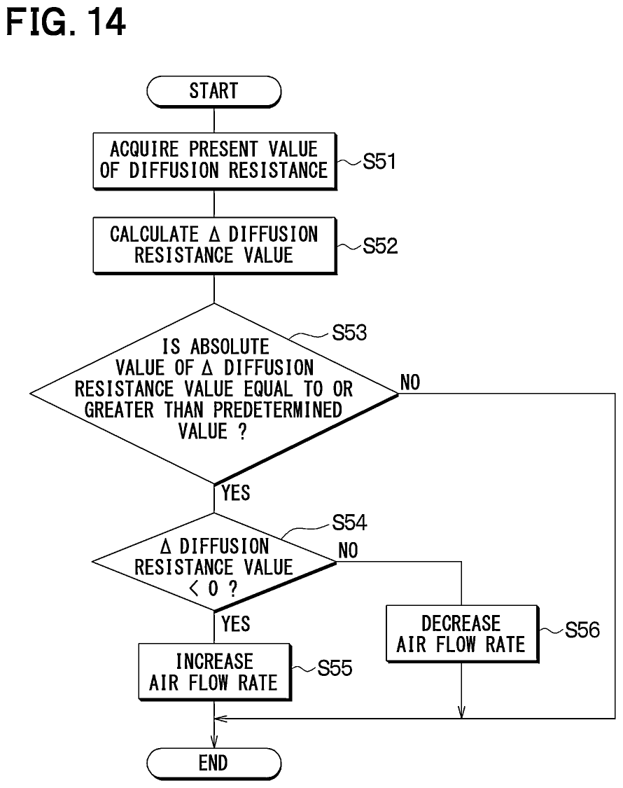

In the diffusion resistance control, the control unit 70 executes a control process shown in FIG. 14. The control process shown in FIG. 14 is repeated until its execution is stopped.

As shown in FIG. 14, in S51, the control unit 70 acquires the present value of the diffusion resistance. At this time, the present value of the diffusion resistance is calculated by the above-described calculation method.

Next, in S52, the control unit 70 calculates a Δ diffusion resistance value, which is the difference between the present value of the diffusion resistance and the target value of diffusion resistance, using the present value of the diffusion resistance acquired in S51 and the target value of the diffusion resistance stored in the control unit 70.

Next, in S53, the control unit 70 determines whether or not the absolute value of the A diffusion resistance value calculated in S52 is equal to or greater than a predetermined value. If the determination in S53 is NO, the control unit 70 temporarily ends this process. If the determination in S53 is YES, the control unit 70 proceeds to S54.

In S54, the control unit 70 determines whether or not the A diffusion resistance value calculated in S52 is a negative value.

If the present value of the diffusion resistance is greater than the target value of the diffusion resistance and the A diffusion resistance value is a negative value, the control unit 70 makes a YES determination in S54. In this case, the control unit 70 proceeds to S55, and controls the operation of at least one of the air compressor 41 and the flow dividing valve 43 to increase the air flow rate so as to decrease the diffusion resistance value. As a result, the diffusion resistance value changes in such a manner that the present value of the diffusion resistance approaches the target value of the diffusion resistance. Thereafter, the control unit 70 temporarily ends this process.

On the other hand, if the present value of the diffusion resistance is smaller than the target value of the diffusion resistance and the A diffusion resistance value is a positive value, the control unit 70 makes a NO determination in S54. In this case, the control unit 70 proceeds to S56, and controls the operation of at least one of the air compressor 41 and the flow dividing valve 43 to decrease the air flow rate so as to increase the diffusion resistance value. As a result, the diffusion resistance value changes in such a manner that the present value of the diffused resistance value approaches the target value of the diffused resistance value. Thereafter, the control unit 70 temporarily ends this process.

In this manner, the control unit 70 acquires the present value of the diffusion resistance. The control unit 70 controls the operation of at least one of the air compressor 41 and the flow dividing valve 43 so as to change the diffusion resistance in such a manner that the present value of the diffusion resistance that is acquired approaches the predetermined target value of the diffusion resistance. In the present embodiment, the diffusion resistance corresponds to a third state quantity. The target value of the diffusion resistance corresponds to a third target value. The air compressor 41 and the flow dividing valve 43 correspond to third actuators capable of adjusting the third state quantity. The above-described control of the air compressor 41 and the like corresponds to a third control.

Here, the present embodiment and Comparative Example 4 are compared. In Comparative Example 4, unlike the present embodiment, the control unit 70 increases the air flow rate when it is determined from the operating state of the FC 20 that flooding (that is, water clogging inside the air electrode 24) has occurred.

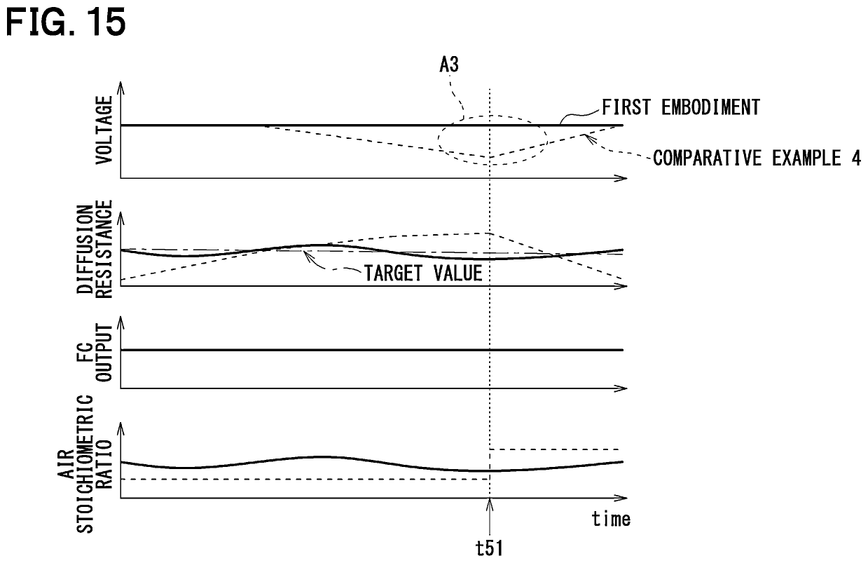

In this case, as shown in FIG. 15, when the FC output is a predetermined value greater than 0, since water is produced by power generation by the FC 20 before time t51, the diffusion resistance increases over time. At time t51, it is determined that flooding has occurred, and the air flow rate is increased. After time t51, an air stoichiometric ratio becomes larger than before time t51. In Comparative Example 4, the diffusion resistance increases until it is determined that flooding has occurred. The voltage of the FC 20 decreases with increase in the diffusion resistance. Therefore, the voltage fluctuation range of the FC 20 is large.

In contrast, in the present embodiment, the control unit 70 performs the above-described diffusion resistance control. In this case, as shown in FIG. 15, the air flow rate is adjusted and the diffusion resistance is maintained at a value close to the target value. Since the air flow rate is constantly adjusted during power generation by the FC 20, the air stoichiometric ratio constantly fluctuates. Since the diffusion resistance is maintained at the value close to the target value, the voltage fluctuation width of the FC 20 can be made smaller than that of Comparative Example 4, as shown in area A3 of FIG. 15.

In this way, according to the present embodiment, the diffusion resistance is controlled so as to approach the target value. This makes it possible to decrease voltage fluctuations caused by variations in the diffusion resistance. As a result, deterioration of the power generation performance of the catalyst included in the air electrode 24 can be restricted.

Furthermore, according to the present embodiment, the control unit 70 performs the diffusion resistance control after performing the membrane humidity control and the catalytic oxide film ratio control. Therefore, during the diffusion resistance control, the control unit 70 detects the diffusion resistance when the membrane humidity and the catalytic oxide film ratio are close to their respective target values. This makes it possible to improve the detection accuracy of the diffusion resistance.

### Second Embodiment

In the present embodiment, the control unit 70 performs the membrane humidity control and then the diffusion resistance control. The respective control contents of the membrane humidity control and the diffusion resistance control are the same as those in the first embodiment. In the present embodiment, the membrane humidity corresponds to a first state quantity. The membrane humidity control corresponds to a first control. The humidifier 44 corresponds to a first actuator. The diffusion resistance corresponds to a second state quantity. The diffusion resistance control corresponds to a second control. The air compressor 41 and the flow dividing valve 43 correspond to second actuators.

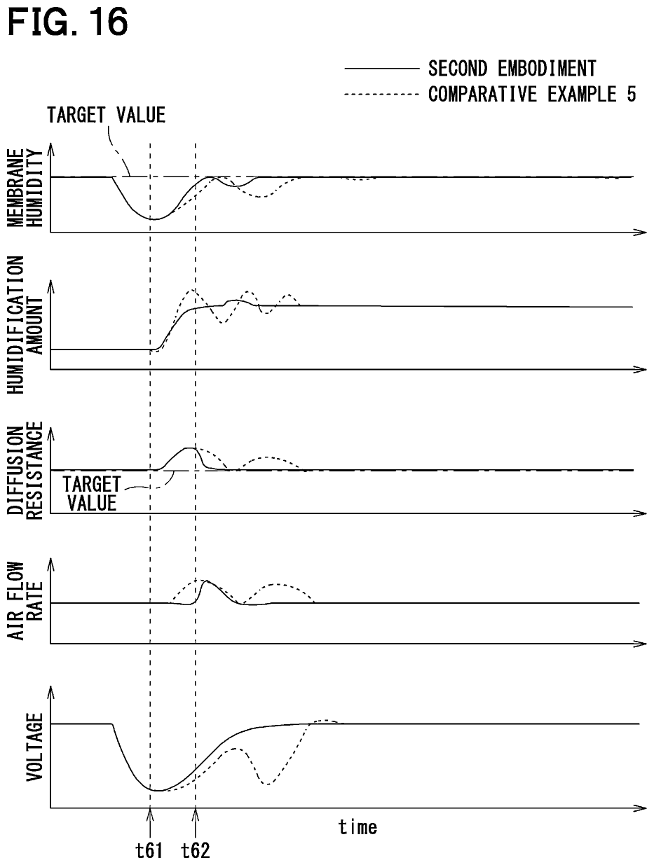

Here, the present embodiment and Comparative Example 5 are compared. In the time chart of FIG. 16, dashed lines indicate Comparative Example 5, and solid lines indicate the present embodiment. The membrane humidity corresponds to a first state quantity. The diffusion resistance corresponds to a second state quantity.

In Comparative Example 5, at time t61, the control unit 70 simultaneously starts the membrane humidity control and the diffusion resistance control. At time t61, the present value of the membrane humidity is lower than the target value. Therefore, the control unit 70 increases the humidification amount in order to bring the present value of the membrane humidity closer to the target value. When the humidification amount increases, condensed water is generated inside the air electrode 24, and the diffusion resistance increases. When the present value of the diffusion resistance becomes greater than the target value, the control unit 70 increases the air flow rate in order to bring the present value of the diffusion resistance closer to the target value. When the air flow rate increases, the amount of water carried away from the electrolyte membrane increases, and the membrane humidity decreases.

In this manner, in Comparative Example 5, when an actuator capable of adjusting one state quantity is operated, the operation quantity affects a different state quantity. That is, the different state quantity fluctuates away from the target value. For this reason, the state quantities of the membrane humidity and the diffusion resistance repeatedly fluctuate to approach and deviate from the target values. It takes time for each state quantity to approach the target value. Furthermore, when the state quantities of the membrane humidity and the diffusion resistance fluctuate, the output voltage of the FC 20 fluctuates.

In contrast, in the present embodiment, the control unit 70 starts the membrane humidity control at time t61. Then, at time t62 after the membrane humidity has approached the target value through the membrane humidity control, the control unit 70 starts the diffusion resistance control. In other words, when performing membrane humidity control, the control unit 70 controls the operation of the humidifier and the operation of the actuator that adjusts the air flow rate so that the influence of the operation of the actuator that adjusts the air flow rate on the membrane humidity is small. Furthermore, in other words, when performing membrane humidity control, the control unit 70 controls the operation of the actuator that adjusts the air flow rate so that the membrane humidity is restricted from changing away from the target value due to the operation of the actuator that adjusts the air flow rate.

According to this method, the diffusion resistance control does not interfere with the membrane humidity control. Fluctuations in the membrane humidity approaching or deviating from the target value can be decreased. Therefore, the time required for the membrane humidity to approach the target value after the membrane humidity control is started can be shortened.

Furthermore, when the diffusion resistance control is performed, since the previously adjusted membrane humidity is close to the target value, the fluctuation in membrane humidity caused by the influence of the diffusion resistance control is small. Therefore, the influence of the membrane humidity control on the diffusion resistance control can be small. It is possible to decrease the fluctuation of the diffusion resistance approaching or deviating from the target value.

In this way, by decreasing the fluctuations in the membrane humidity and the diffusion resistance, according to the present embodiment, as shown in FIG. 16, it is possible to restrict the voltage fluctuation of the FC 20 to a smaller value compared to Comparative Example 5. As a result, deterioration of the power generation performance of the catalyst included in the air electrode 24 can be restricted.

In the present embodiment, the control unit 70 detects the membrane humidity and performs membrane humidity control to bring the present value of the membrane humidity closer to the target value. However, the control unit 70 may detect a H⁺ conductivity (that is, proton conductivity) instead of the membrane humidity, and perform control to bring the present value of H⁺ conductivity closer to a target value. The H⁺ conductivity has a predetermined relationship with the membrane humidity and is a physical quantity related to the membrane humidity.

### Other Embodiments

In the above embodiment, the membrane humidity, the catalytic oxide film ratio, and the diffusion resistance are calculated using the model formulas. However, the calculations may be performed using a multidimensional map that uses variables such as sensor values as inputs.

The present disclosure is not limited to the foregoing description of the embodiments and can be modified. The present disclosure may also be varied in many ways. Such variations are not to be regarded as departure from the disclosure, and all such modifications are intended to be included within the scope of the disclosure. The above-described embodiments are not independent of each other, and can be appropriately combined except when the combination is obviously impossible. The constituent element(s) of each of the above embodiments is/are not necessarily essential unless it is specifically stated that the constituent element(s) is/are essential in the above embodiment, or unless the constituent element(s) is/are obviously essential in principle.

The control unit and the method described in the present disclosure may be implemented by a special purpose computer which is configured with a memory and a processor programmed to execute one or more particular functions embodied in computer programs of the memory. Alternatively, the control unit and the method described in the present disclosure may be implemented by a special purpose computer configured as a processor with one or more special purpose hardware logic circuits. Alternatively, the control unit and the method described in the present disclosure may be implemented by one or more special purpose computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium.

What is claimed is:

1. A fuel cell system comprising:
a fuel cell including an electrolyte membrane made of a solid polymer, a fuel electrode disposed on one side of the electrolyte membrane, and an air electrode disposed on another side of the electrolyte membrane;
a first actuator capable of adjusting a first state quantity indicating an internal state of the fuel cell;
a second actuator capable of adjusting a second state quantity different from the first state quantity and indicating the internal state of the fuel cell; and
a control unit configured to control operation of the first actuator and operation of the second actuator, wherein
the control unit is configured to perform a first control and a second control, the first control includes acquiring a present value of the first state quantity and controlling the operation of the first actuator so as to change the first state quantity in such a manner that the present value of the first state quantity that is acquired approaches a predetermined first target value, and the second control includes acquiring a present value of the second state quantity and controlling the operation of the second actuator so as to change the second state quantity in such a manner that the present value of the second state quantity that is acquired approaches a predetermined second target value,
when performing the first control, the control unit controls the operation of the second actuator so that the first state quantity is restricted from changing away from the first target value due to the operation of the second actuator,
the first state quantity is a relative humidity of the electrolyte membrane or a physical quantity related to the relative humidity, and
the second state quantity is a gas diffusion resistance of the air electrode.

2. A fuel cell system comprising:
a fuel cell including an electrolyte membrane made of a solid polymer, a fuel electrode disposed on one side of the electrolyte membrane, and an air electrode disposed on another side of the electrolyte membrane;
a first actuator capable of adjusting a first state quantity indicating an internal state of the fuel cell;
a second actuator capable of adjusting a second state quantity different from the first state quantity and indicating the internal state of the fuel cell; and
a control unit configured to control operation of the first actuator and operation of the second actuator, wherein
the control unit is configured to perform a first control and a second control, the first control includes acquiring a present value of the first state quantity and controlling the operation of the first actuator so as to change the first state quantity in such a manner that the present value of the first state quantity that is acquired approaches a predetermined first target value, and the second control includes acquiring a present value of the second state quantity and controlling the operation of the second actuator so as to change the second state quantity in such a manner that the present value of the second state quantity that is acquired approaches a predetermined second target value,
the first state quantity is a relative humidity of the electrolyte membrane or a physical quantity related to the relative humidity,
the second state quantity is a gas diffusion resistance of the air electrode, and
the control unit is configured to perform the second control after performing the first control.

3. A fuel cell system comprising:
a fuel cell including an electrolyte membrane made of a solid polymer, a fuel electrode disposed on one side of the electrolyte membrane, and an air electrode disposed on another side of the electrolyte membrane;
a first actuator capable of adjusting a first state quantity indicating an internal state of the fuel cell;
a second actuator capable of adjusting a second state quantity different from the first state quantity and indicating the internal state of the fuel cell; and
a control unit configured to control operation of the first actuator and operation of the second actuator, wherein
the control unit is configured to perform a first control and a second control, the first control includes acquiring a present value of the first state quantity and controlling the operation of the first actuator so as to change the first state quantity in such a manner that the present value of the first state quantity that is acquired approaches a predetermined first target value, and the second control includes acquiring a present value of the second state quantity and controlling the operation of the second actuator so as to change the second state quantity in such a manner that the present value of the second state quantity that is acquired approaches a predetermined second target value,
the first state quantity is a relative humidity of the electrolyte membrane or a physical quantity related to the relative humidity,
the second state quantity is an oxide film ratio of a catalyst included in the air electrode,
the control unit is configured to perform the second control after performing the first control,
the fuel cell system further comprises a third actuator capable of adjusting a gas diffusion resistance of the air electrode as a third state quantity indicating the internal state of the fuel cell, and
the control unit is configured to perform a third control after performing the second control, and the third control includes acquiring a present value of the third state quantity and controlling operation of the third actuator so as to change the third state quantity in such a manner that the present value of the third state quantity that is acquired approaches a predetermined third target value.
